(19) United States
(12) Patent Application Publication
(10) Pub. No.: US 2012/0114449 A1
(43) Pub. Date: May 10, 2012

(54) FASTENER

(76) Inventor: Mark A. Farrell, Arlington, WA (US)

(21) Appl. No.: 12/942,814

(22) Filed: Nov. 9, 2010

(51) Int. Cl. F16B 21/00

(52) U.S. Cl. 411/500

(57) ABSTRACT

A one piece fastener made from high strength steel for securing a work piece to a metal substrate and including an elongated substantially flat body defining a void extending substantially along the length of the body, a crown at one end of the body formed by substantially symmetrical halves extending outwardly from the flat body and formed integrally therewith. A gripping and clamping member is disposed within the void in the elongated body and is affixed at each end thereof to the body and defines at least first and second teeth extending outwardly therefrom, the gripping and clamping member being rotated. A piercing tip formed at the opposite end of the elongated body for generating an opening through the work piece and the metal substrate, the piercing tip formed from a plurality of incrementally wider steps progressing from the tip toward the width of the body.

### FIELD OF THE INVENTION

This invention relates to fasteners and more particularly to a fastener that is used to attach a laminar work piece to a metal substrate with the fastener being inserted through the utilization of an appropriate power tool.

### BACKGROUND OF THE INVENTION

The present invention is an improvement over the fastener shown in U.S. Pat. No. 6,659,700 and the fastener disclosed therein is illustrated as prior art in FIG. 1. The need for a self-piercing construction fastener that can penetrate less dense laminar work piece materials (i.e. gypsum drywall, cementatious products, layered fiberglass and the like) and connect them to supporting walls of metal substrate framing (such as studs) made from light gage metal is well known. Such fasteners include a holding and clamping member that has resiliency and can move along a plane or between planes during the metal penetration process, and then return to its original form, thereby creating a combined friction and mechanical lock. Various designs of a laminar-to-metal-studs wall-fastening member have been in existence for a number of years. An advanced type is described in U.S. Pat. No. 6,659,700 as shown in FIG. 1. It comprises a fastener with a head 10 bent over at or near ninety (90) degrees; a flat elongated body 12 containing at least one, thinned, resilient tine 14 disposed within a void 15 in the body and twisted at an angle to the plane of the fastener body; small, equally spaced, equally formed teeth 16 upon the edges of the tine 14; and a sword-like point 18, all made from one-piece of thin sheet metal. After insertion, via velocity produced by a power tool, the fastener body and tine follows the point through the less dense work piece material and then through a hole in the metal substrate opened by the point. The toothed-tine, meeting the resistance of the substrate metal stud, rotates to a near flatness, parallel to the body plane. After passing through the metal substrate, the toothed-tine rotates back nearly to its original form, causing the teeth to produce a mechanical lock on the underside of the metal substrate.

The ability of the fastener to penetrate the bottom metal stud and its withdrawal resistance from the metal stud depend to a large degree on the material used to form the fastener. Thus it is desirable to employ thin sheet metal of high strength, such as for example, spring steel metal or the like. To facilitate manufacturing, it would be desirable to use a soft malleable material which can be easily shaped, cut and folded with conventional dies. However, such a product, lacking sufficient carbon, cannot be strengthened sufficiently by heating and quenching, then tempering. Any process using less than high strength (spring steel) would not allow sufficient integrity of the thin fastener body to resist bending. Additionally, the tine essentially being a torsion spring requires a material that retains the resiliency of this component hence spring steel must be used.

Conventionally, with this type of fastener, a head is formed by bending over material from the top of the fastener body into some form. Fastener inventions incorporating such heads are formed within a stamping operation via bending. The head may be a T, L or U shape, but all are created by the bending process. These forms generate sharp edges along at least two sides (the nature of bending to form a head from flat metal). These sharp edges cut through the top layers of less-dense laminar work pieces, thereby eliminating this head style from industry accepted standards. It has been found that a fastener head formed from bent-over tabs the thickness of the fastener material are unsuccessful in the softest laminar work pieces such as gypsum drywall. The head, whether facing in one direction or in opposing directions, has sharp edges along all three sides and cut through the gypsum drywall top laminar work piece paper layer, thereby causing this form of a head to be unacceptable in the industry. Even if multiple layers of fastener material are bent over themselves, forming a radius at their furthest extension are used, the edges of the head still contain ninety-degree edges of such sharpness to cut the top paper layer of the drywall material.

Another problem with prior art, self-piercing fasteners made from one-piece metal is the sword-like design of the point. It has been found that when a self-piercing point penetrates a metal substrate, current sword-style points deflect the substrate away from the material being attached to such a degree that the plasticity (memory) of the metal has been exceeded. Therefore, the metal cannot return to its original form and, consequently, a gap forms between the metal stud and the work piece material being fastened to the stud. This results in a loose and industry-unacceptable fastening joint. It has been discovered that this occurs when any style point widens the penetrated slot to the width of the fastener body in one continuous operation.

Another problem with prior art, self-piercing fasteners made from one-piece metal and containing a resilient, twisted tine is the area of attachment between fastener body and tine. If the tine connection is of substantial width and the moment of bending is near the attachment area, this area can experience tearing or fracturing of the attachment area due to forces of torque applied during the installation process, thereby destroying the integrity of the tine.

Another problem with the prior art invention of a self-piercing fastener with a toothed tine is that, on occasion, thinner substrate metals (thinner than 25 gage) and softer metals (i.e. aluminum) do not provide the stiffness or resistance to properly unwind the tine. Hence, the toothed tine either saws or rips through the metal substrate thereby removing material from the formed opening or slot at precisely the point where it is required for an individual tooth to accomplish a mechanical lock.

Another problem with prior art, self-piercing fasteners made from one-piece metal and containing a resilient, twisted tine with numerous, smaller, equally spaced and equally formed teeth upon the tine edges is that such teeth are unsuccessful in allowing the tine to properly function, and they do not properly lock under the bottom of the metal substrate. In prior art fasteners, the teeth were designed to be non-discriminatory as to thickness of work piece material being fastened to the metal stud. That is, several different thickness of work piece material (within a range) could be attached with the same fastener without regard to positioning of teeth along the tine. With numerous, small teeth, it was thought, any opposing two of the teeth would “catch” when the fastener came to a stop. It has been found that this does not occur. This design of tine teeth does not provide a smooth transition of the unwinding and then return (rotation) of the tine to the nearly original position when passing through the metal substrate pierced opening. Smaller teeth beginning at or near the bottom tine attachment do not allow proper unwinding, while these same teeth upward on the tine act as saw-teeth, cutting laterally into the metal substrate pierced slot instead of passing through the slot in an unwound position, thereby removing material from the slot at precisely the point where it is required for the individual tooth to provide a mechanical lock. Additionally, one tooth may be within the pierced hole created by the self-piercing point when the fastener comes to a halt during installation. That tooth does not allow the tine to rotate back to nearly its prior position, and further does not allow the tooth on the underside of the metal stud to achieve a mechanical locking state underneath the bottom of the metal stud. Additionally, these smaller teeth provide insufficient bearing upon the underside of the metal substrate, required for maximum withdrawal resistance.

Another problem with prior art, self-piercing fasteners made from one-piece metal is that during secondary manufacturing processes of the fastener, the fasteners can clump or become intertwined, thereby disabling the ability to properly heat-treat, plate and collate fasteners, The area of greatest problem is when a fastener point inserts itself substantially into the interior void surrounding the tine of another fastener. With the prior art fastener body thickness, the tine and void are of such diminutive nature, that no process allows the forming of anti-nesting devices from only profile stamping of material existing within the yet-to-be-stamped void.

Various forms of fasteners, some including metal penetrating capability are disclosed in the following prior art references:

| Patent No. | Inventor |
|---|---|
| 1,338,988 | Kinoshita |
| 1,417,818 | Frost |
| 1,934,134 | McChesney |
| 2,110,959 | Lombard |
| 2,155,893 | Fulton |
| 2,168,854 | Agnew |
| 2,319,058 | Hansman |
| 2,353,579 | Miller |
| 2,382,474 | Gambo |
| 2,530,229 | Clark |
| 2,543,212 | Waara |
| 2,564,643 | Hall |
| 2,614,450 | Oltz et al. |
| 2,740,505 | Flora |
| 2,751,052 | Flora |
| 2,958,562 | Jones |
| 3,618,447 | Gains |
| 3,675,958 | Duffy |
| 3,800,653 | Barth et al. |
| 3,882,755 | Enstrom |
| 3,973,295 | Janke |
| 3,983,779 | Dimas |
| 5,152,582 | Magnuson |
| 5,597,280 | Stern |
| 5,846,019 | Kuhns |
| FR1.202.255 | |

192,492 British Provisional Specification filed Nov. 3, 1921, accepted Feb. 05, 1923

There is thus a need in the industry for a self piercing metal fastener constructed from a single member of high strength metal which includes an integral head which does not have sharp edges and which will not cut the top paper layer of a drywall material, which has a piercing point which will incrementally and gradually form an opening in the metal substrate without deflecting the metal substrate beyond its range of elasticity, which has an attachment of a clamping and gripping member formed with the fastener which provides greater rotation of the gripping and clamping member without exerting stress forces causing the attachment area to tear or fracture, which includes spaced apart teeth on the gripping and locking member which will permit attachment of different sizes of work piece material to a metal substrate, and which will allow the formation of anti-nesting devices within the fastener.

### SUMMARY OF THE INVENTION

A one piece fastener made from high strength steel for securing a work piece to a metal substrate which includes an elongated substantially flat body having first and second ends and first and second oppositely disposed faces and first and second side edges. A crown formed from substantially symmetrical halves extending outwardly from the first and second faces of the body, a piercing tip formed at the second end of the body for incrementally generating an opening in the metal substrate and at least one gripping and clamping member on the body to lock the work piece and the metal substrate together.

### BRIEF DESCRIPTION OF THE DRAWINGS

FIG. 1 is a perspective view of a prior art fastener;

FIG. 2 is perspective view of the fastener of the present invention;

FIG. 3 is a front elevational view of a fastener constructed in accordance with the principals of the present invention;

FIG. 4 is a side view of the fastener shown in FIG. 2;

FIG. 5 is a front elevational view showing the fastener of FIG. 2 and an intermediate stage of construction;

FIG. 6 is a side view of FIG. 5;

FIG. 7 illustrates the progressive stamping which is utilized to form the fastener of the present invention;

FIG. 8 is a partial view of the fastener of the present invention illustrating the piercing point in greater detail;

FIG. 9 is a partial view of the fastener of the present invention illustrating the manner in which the clamping and the gripping member is formed with specific reference to the gripping teeth thereon;

FIG. 10 illustrates the fastener of the present invention attaching a work piece to a metal stud which is of a first dimension;

FIG. 11 illustrates attaching a work piece to metal substrate with the work piece being of a smaller dimension;

FIG. 12 illustrates the formation of anti-nesting members on the fastener of the present invention; and

FIG. 13 illustrates an alternative embodiment of the fastener of the present invention including a gripping and clamping member which extends substantially the entire length of the void provided to receive such clamping and gripping member.

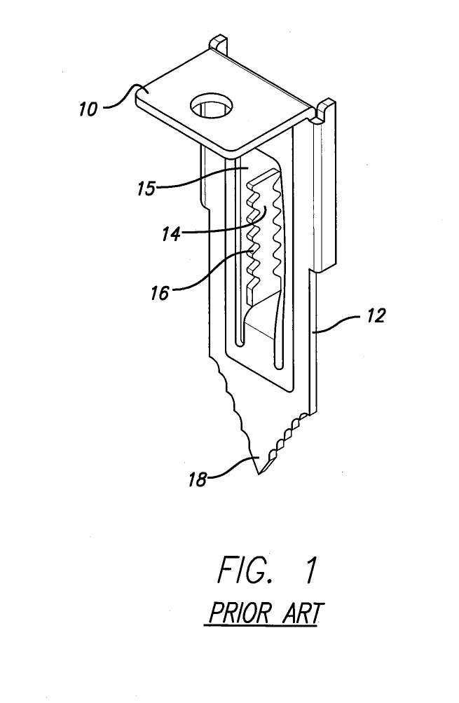

### DETAILED DESCRIPTION OF THE INVENTION

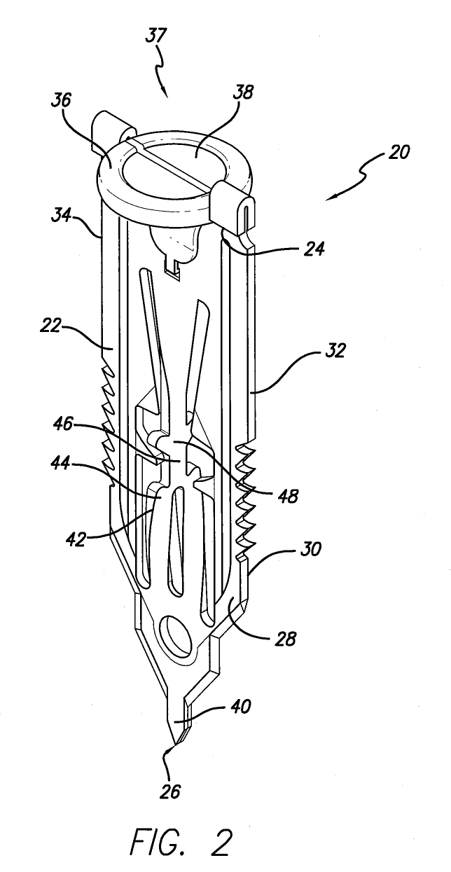

Referring to the drawings and more particularly to FIG. 2 thereof, there is illustrated in perspective view the fastener 20 of the present invention. The fastener 20 includes a flat elongated body 22 having a first 24 end and second end 26. The body 22 includes a first flat surface or face 28 and second flat surface or face 30 which is on the opposite side of the flat elongated body 22. The body also includes first side edge 32 and second side edge 34. Disposed adjacent the first end 24 of the body is a crown 37 which is formed from first 36 and second 38 substantially symmetric halves extending radially outwardly from the first flat surface 28 and the second flat surface 30 respectively. There is a piercing tip 40 formed at the second end 26 of the body 22 and there is a clamping and gripping member 42 connected to the flat body 22 at each end of the clamping and gripping member 42. The gripping and clamping member 42 includes a first tooth 44 which is formed by reducing the width of the gripping and clamping member from and initial root width as shown at “W” to a smaller root width as shown at 46. Displaced upwardly toward the crown from the first tooth 44 is a second tooth 48 which extends upwardly and outwardly from the second root width 46. The teeth 44 and 48 are utilized to clamp work pieces of different width to a metal substrate. Additional details of the various components of the fastener 20 as illustrated in FIG. 2 are illustrated in the remaining figures and will be described in greater detail herein below.

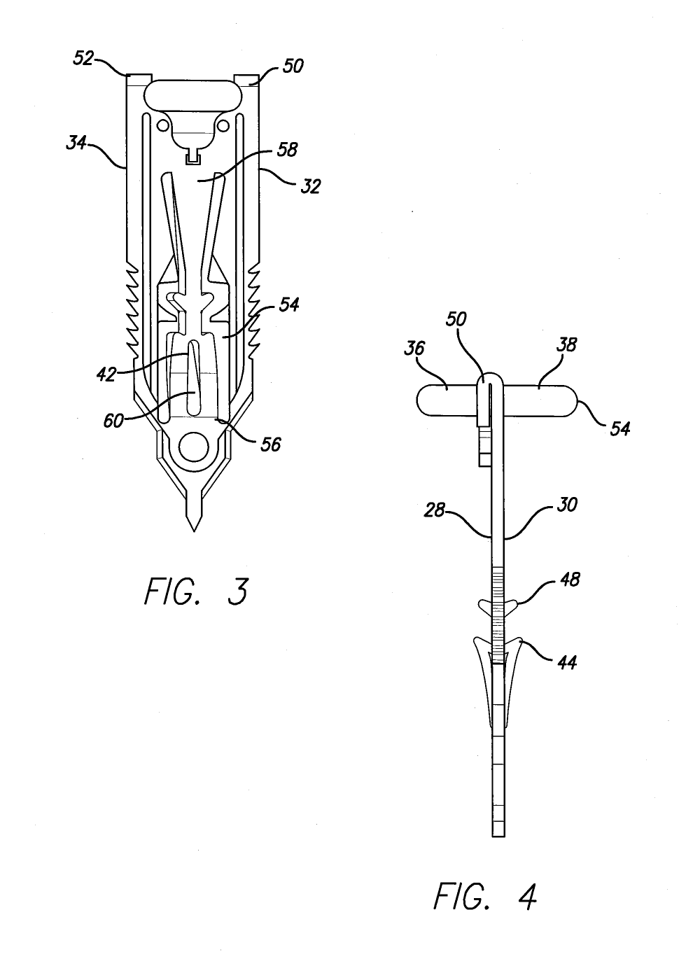

FIG. 3 is a front elevational view of the fastener as illustrated in FIG. 2 and FIG. 4 is a side view thereof. As is illustrated in FIGS. 3 and 4 the symmetrical halves 36 and 38 of the crown are interconnected by a first strap 50 and a second strap 52 disposed at the first and second side edges 32 and 34 respectively of the flat elongated body 22. The straps 50 and 52 are bent approximately 180 degrees at their midsection as is illustrated particularly in FIG. 4 to cause the two symmetrical halves of the crown to become aligned so that they extend radially outwardly from the first and second flat faces 28 and 30. As is also shown particularly in FIG. 4, as well as the perspective view of FIG. 2, the outer periphery of the first and second symmetrical halves 36 and 38 of the crown are arcuately shaped as shown at 54 to eliminate any sharp edges which would tend to cut into the surface of the wall board which would be fastened to a metal stud as above described.

As is shown in more detail in FIG. 3 the gripping and clamping member 42 is disposed within a void 54 formed substantially centrally of the flat body 22. The gripping and clamping member is formed integrally with the body 22 and is connected at its lower end 56 to the body 22 adjacent the second end 26 thereof but displaced from the piercing tip 40. The upper end 58 of the gripping and clamping member is connected adjacent, but spaced from the second end 24 of the body 22. The gripping and clamping member 42 also defines a void 60 extending from substantially adjacent the connection at its lower end 56 upwardly toward to a point adjacent the first tooth 44. As illustrated in FIGS. 2, 3 and 4 the gripping and clamping member 42 is twisted or rotated so that the teeth 44 and 48 extend outwardly from the first and second faces 28 and 30 of the body 22. The fastener of the present invention is formed from high strength material and preferably spring steel and is thin, that is formed in a manner such that it is thinner than the thickness of the body 22 so that it will tend to move toward a flat position within the void of the body 22 when it is inserted through the metal substrate but when it comes to rest will return to the position as illustrated in FIGS. 2, 3 and 4 thereby clamping the work piece to the metal stud. By providing the void 60 in the gripping and clamping member 42 this twisting and untwisting of the gripping and clamping member is facilitated and also eliminates any tendency for the gripping and clamping member to break at its connection points 56 and 58 to the body.

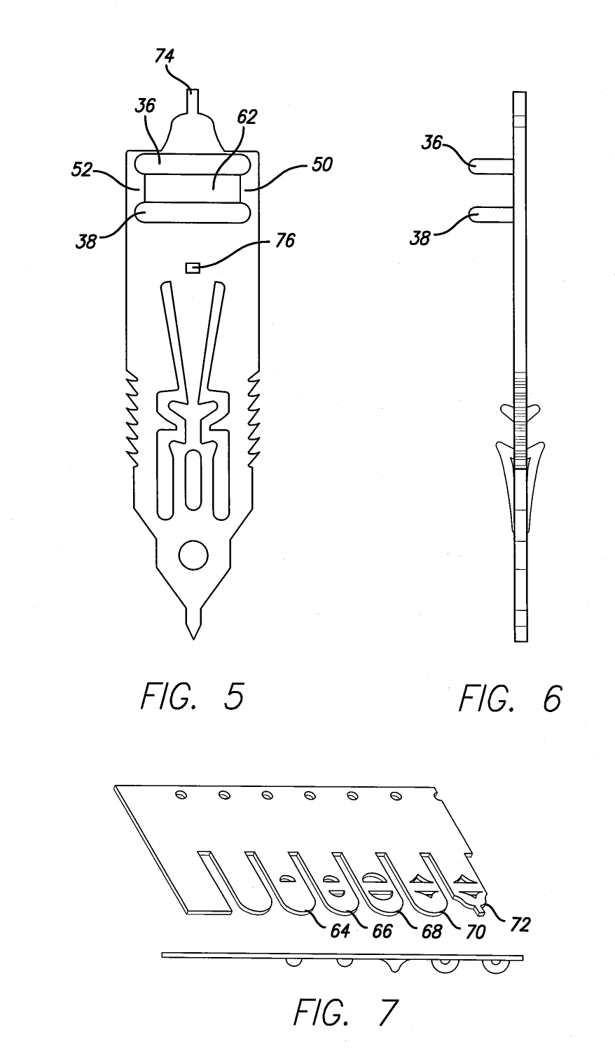

Referring now more particularly to FIGS. 5, 6 and 7, a solution to the problem of head design described above is addressed by draw-forming the two symmetrical halves 36 and 38 of the head from the top portion of the material forming the fastener body with one-half a nearly mirror image of the other and placed above the other half head as shown in FIG. 6. If the entire head top surface is allowed to remain, it will crack when bent to position the head halves and the two head halves will break apart. The reason the bend area will crack is that it has become work-hardened during the deep-drawing process. The solution is a relief in the form of a void 62 as shown in FIG. 5 within the center connection area. However, the final outside area of the head has not been work-hardened, so two connecting straps or bands 50 and 52 on the sides of the head perimeter, which span this void and hold the two head-halves together during and after bend-over, maintain their integrity without cracking or breaking apart. The deep-drawing process is to form each head-half in multiple steps within the progressive-stamping process, each time moving the material somewhat closer to final form as shown at 64, 66, 68, 70 and 72 in FIG. 7. Each head-half is formed with a smooth outer arcuate rim 54. When the top head-half is bent over to mate with the other half there is need of attachment points between the two halves. After bending over of the top-head half a tab 74 attached to its bottom is press-fit into a mating hole 76 within the fastener body, thereby securing the fastener head-halves together. Additionally, material in the form of other tabs may extend from each side of the head-halves. Such additional tabs can be used to further anchor the bent-over, mating head to body via compression (or “staking”) a substantial portion of the tab through mating holes within the body. After the two halves of the head are secured together, the two connecting bands may remain in their bent-over position (extending above the head) FIG. 3, or may be sheared off in another step and swaged together, now being flush with the head top.

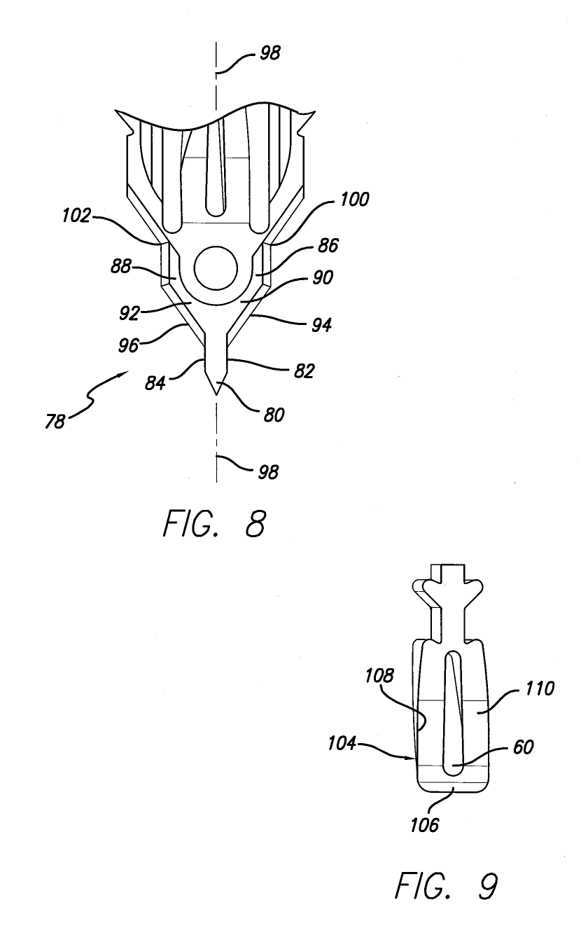

Referring now more particularly to FIG. 8, a solution for the problem of fastener point metal substrate or stud deflection described above is through incorporation of a point 78 that reduces this stud deflection during point penetration, thereby allowing it to return to its original form. Such a fastener point is a “step” point because there are multiple, upward steps to its form. The point begins with a narrow, angled piercing point 80 with straight sides 82 and 84, stepping outward to progressively wider point planes 86 and 88. Each step has an angled transition 90, 92 from the last step to the next wider step. The transition may or may not be beveled as shown at 94, 96 for sharpness of cutting. However, after this transition between steps, the sides of each step are parallel to the sides 32, 34 of the fastener. Alternatively, the side edges of each step in the piercing point 78 may be slanted inwardly toward the longitudinal axis 98 of the body as shown at 100, 102 and allow the metal substrate to return to its original position between steps of penetration by the point. The purpose of these steps is to allow penetration of the metal incrementally. The angled and narrow lead point introduces initial point penetration of the metal via minimum width. Then the sides of the point, parallel to the body or slanted inwardly, follow through the hole created by the initial penetration without causing any further deflection of the metal. During this millisecond “rest” period, two things have occurred: the metal substrate has not been deflected past its plasticity point and the metal substrate has time to return to its original position prior to further penetration of the point. After this penetration, the hole is progressively widened by the transition area to the next step. Penetration and subsequent forming of the hole in the metal substrate is incremental and progressive, thereby avoiding over-deflection of the metal substrate. The material is allowed to return to its original form and the fastening joint between the work piece and the metal substrate maintains its integrity.

Referring now more particularly to FIG. 9, a solution to the problem of the clamping and gripping member tearing or cracking at its attachment point to the body is illustrated. This is accomplished by forming a void 60 within and slightly above the attachment area 106 upward toward the crown. This internal void 60 creates a fork at the attachment site, creating two legs 108, 110. When the clamping and gripping member is rotated during installation, these legs 108, 110 act as independent torsion bars, twisting different arcs and upon different planes. This reduces the stress upon the attachment area 106 and eliminates the problem of failure of the body 104 attachment.

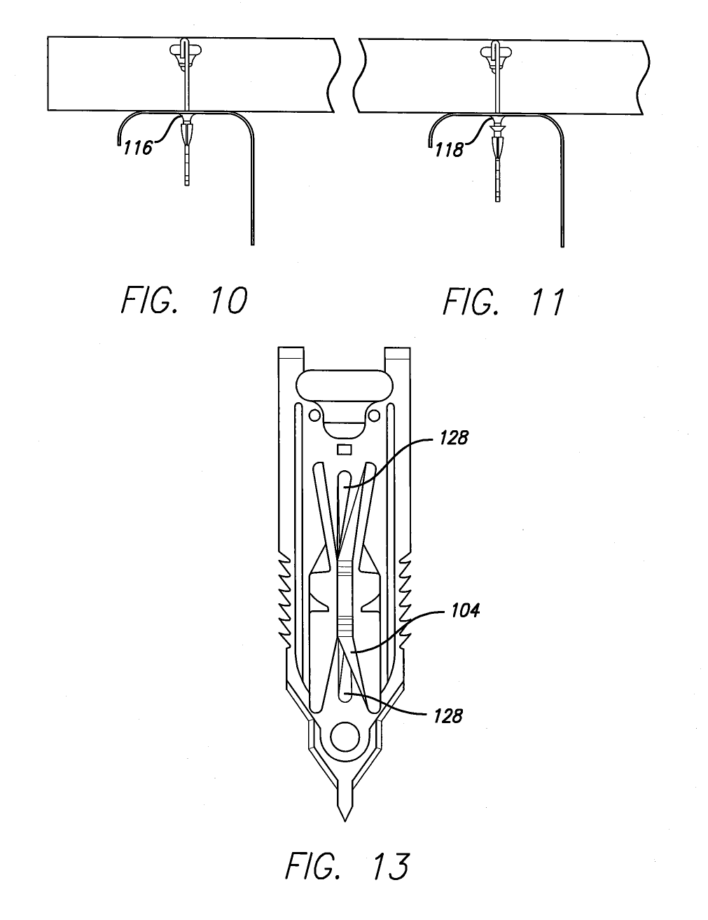

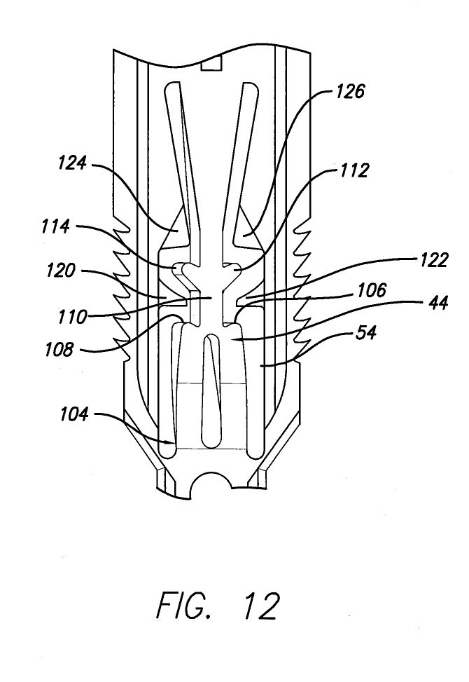

Referring now more particularly to FIG. 12, the problems incurred through use of numerous, small, equally spaced, equally formed gripping teeth is successfully addressed by providing only two or three teeth at pre-set distances from the fastener head, with distances of a smooth (no teeth) reduced clamping and gripping member root between teeth. The teeth, being of greater distance apart than those of the prior art, can now be formed wider and taller, thereby increasing their shear strength while providing greater bearing surface upon the pierced metal substrate underside, resulting in greater withdrawal resistance. The teeth are of different shape for the bottom tooth 44 (thicker work piece) as opposed to the upper (thinner work piece) tooth 48. The bottom tooth 44 is made from the largest width of the clamping and gripping member body 104 root area, then by cutting perpendicular to the sides of the body 104 into the vertical plane of the body 104, thereby reducing body 104 root width. The far outside 106, 108 of the subsequent opposing ledges forming the teeth project outward slightly from the body 104 root width, and upward, providing a slight arc (cupped) shape to the top of the tooth substantially perpendicular to the body 104 sides and a curved terminus. This aids in directing withdrawal forces towards the ends of the teeth. The upper tooth 48 begins its bottom body 104 connection at the now reduced root 110 progressing outward acutely to radius ends 112, 114 that turn inward nearly perpendicular to the fastener body 22 sides, until its connection with the body 104 root. This construction of the tooth 48 also provides a slight arc (cupped) shape to the top of the tooth substantially perpendicular to the body 104 sides and a curved terminus. The first tooth 44 to enter the pierced hole within the metal substrate is pre-set for a thicker work piece (i.e. ⅝″ or ¾″) as shown in FIG. 10. Being made from the largest body 104 root, it easily follows the clamping and gripping member into the pierced metal hole, beginning the unwinding (rotation) of the gripping and clamping member. If the fastener were to end installation when this tooth has passed underneath the bottom of the metal substrate, the reduced body 104 root immediately above this bottom tooth 44, and void of any teeth, allows successful return (rotation) of the body 104 back nearly to its original position. If the upper, second tooth 48 is pre-set for thinner work piece (i.e. ¼″ or ⅜″) as shown in FIG. 11, then the first, bottom tooth 44 passes through the pierced hole in the metal substrate, then the reduced body 104 root, and then the acute angle of the second tooth 48 bottom encourages rotation of this second tooth. The radius ends of this second tooth aid in “finding” and passing through the metal substrate pierced hole. The top of this tooth 48 (perpendicular to the body edges) also has a slight arc (cupped) shape. This aids in directing withdrawal forces towards the end of this tooth 48. This second style of tooth and reduced, smooth body 104 root can be replicated above the second tooth if an even thinner work piece is desired to be fastened. The presiding rule, however, is that the distance of the smooth, reduced body 104 root between teeth must be at minimum the distance of the metal thickness and the distance of the extruded metal 116, 118 formed during point penetration as seen in FIGS. 10 and 11.

A solution for the problem of fastener nesting is found through forming anti-nesting tabs 120, 122, 124 and 126 within the void 54 (FIG. 12). As conventional tooling used in progressive stamping requires a minimum thickness in order to maintain its integrity during the stamping process, a profile that would stamp the form of anti-nesting tabs that extended into the area of the void 54 is not currently viable. Therefore, the tabs must be formed via thinning and extruding body material into the void area. Material for this thinning and extruding are not available from the clamping and gripping member as this member has already been thinned to such extent as to provide no further material. Additionally, any protrusion along the body 104 would impede its performance. These anti-nesting tabs are placed in such proximity as to successfully prevent the insertion of one fastener head or point into another during normal manufacturing processes such as heat treating, tempering or forming the fasteners into a continuous roll for insertion into the magazine of a power tool.

In order to maximize the use of the fastener of the present invention within metals thinner than 25 gage and softer than steel (such as aluminum), a toothed clamping and gripping member of the type described above, with a void extended upward the majority of the distance of the body 104 length is shown in FIG. 13. The design of this body 104 includes a central void 128 creating two legs. When the body 104 is rotated during installation, these legs have greater “moment”, act as independent torsion bars, twisting different arcs and upon different planes, providing greater resiliency, thereby properly rotating within thinner and softer materials.

There has thus been disclosed an improved one piece fastener made from high strength steel for securing a work piece to a metal substrate which overcomes the problems of prior art fasteners performing similar functions.

What is claimed:

1. A one-piece fastener made from high strength steel, for securing a work piece to a metal substrate, said fastener comprising:
a) an elongated substantially flat body having first and second ends and first and second oppositely disposed faces and first and second side edges;
b) a crown formed by first and second substantially symmetric halves extending outwardly from said first and second faces respectively of said flat body adjacent said first end thereof, said first and second halves being formed integrally with said flat body;
c) a piercing tip formed at said second end of said elongated body for generating an opening through the work piece and the metal substrate; and
d) at least one gripping and clamping member on said elongated body between said crown and said piercing tip to lock the work piece and the metal substrate together.

2. The fastener as defined in claim 1 wherein said flat body defines an aperture therethrough and one of said first and second halves includes a tab inserted into said aperture to secure said one of said first and second halves to said body.

3. The fastener as defined in claim 1 wherein said first and second halves are interconnected by first and second straps disposed at said first and second side edges respectively, said straps defining a 180° bend at their mid section.

4. The fastener as defined in claim 1 wherein said first and second halves form a radially outwardly extending substantially circular shaped crown having a smooth arcuate periphery.

5. The fastener as defined in claim 1 wherein said piercing tip includes a plurality of incrementally wider steps with an initial step having a narrow width as compared to said body width and sides which are substantially parallel to said first and second side edges, a second step which has a width greater than said initial step but less than said body width and sides which are substantially parallel to said first and second side edges.

6. The fastener as defined in claim 5 which includes an angled transition between said sides of said initial step and said second step and between said sides of said second step and said side edges of said body.

7. The fastener as defined in claim 6 wherein said angled transition between each of said steps is beveled.

8. The fastener as defined in claim 1 wherein said flat body defines a first void therethrough extending along the length thereof from adjacent said crown to adjacent said piercing tip, said gripping and clamping member being disposed within said first void and attached to said body at each end of said first void, said gripping and clamping member defines a second void therethrough extending centrally and longitudinally thereof.

9. The fastener as defined in claim 8 wherein said gripping and clamping member includes first and second spaced apart teeth extending outwardly therefrom, the position of said teeth from said crown being determined by the thickness of said work piece and said substrate, said first tooth having a width equal to the width of said griping and clamping member and being formed by reducing the width of the gripping and clamping member, said second void commencing adjacent said attachment to said body at said piercing point and extending toward said crown and terminates at said first tooth.

10. The fastener as defined in claim 8 wherein said second void extends substantially the entire length of said gripping and clamping member.

11. The fastener as defined in claim 5 wherein the sides of said initial step in said second step or each angled inwardly toward a longitudinal axis of said fastener flat body.

12. The fastener as defined in claim 8 which further includes at least first and second anti-nesting tabs extending into said first void.

13. The fastener as defined in claim 12 wherein said nesting tabs are formed from material of said fastener flat body.

14. A one-piece fastener made from high strength spring steel, for securing a work piece to a metal substrate, said fastener including an elongated substantially flat body having first and second ends and first and second oppositely disposed faces and first and second side edges, a piercing tip formed at said second end of said elongated body for generating an opening through the work piece and the metal substrate, at least one gripping and clamping member on said elongated body between said crown and said piercing tip to lock the work piece and metal substrate together, said fastener characterized by a crown formed by a first and second substantially symmetric halves extending outwardly from first and second faces respectively of said body adjacent said first end thereof, said first and second halves being formed integrally with said flat body.

15. The fastener as defined in claim 9 wherein said second tooth extends outwardly from said reduced width of said gripping and clamping member and is positioned closer to said crown than said first tooth.

16. The fastener as defined in claim 10 wherein each of said teeth have outwardly and upwardly extending arms defining an arcuate upper surface and a curved terminus.

17. A one-piece fastener made from high strength spring steel, for securing a work piece to a metal substrate, said fastener comprising:
(a) an elongated substantially flat body having first and second ends and first and second oppositely disposed faces and first and second side edges; said body defining a first void extending longitudinally along a substantial part of said body.
(b) a crown formed by first and second substantially symmetric halves extending outwardly from said first and second faces respectively of said flat body adjacent said first end thereof, said first and second halves being formed integrally with said flat body;
(c) piercing tip having a plurality of incrementally wider steps with an initial step having a narrow width as compared to said body width and sides which are substantially parallel to said first and second side edges, a second step which has a width greater than said initial step but less than said body width and sides which are substantially parallel to said first and second side edges; and
(d) a gripping and clamping member being disposed within said first void and attached to said body at each end of said first void, said gripping and clamping member defining a second void therethrough extending centrally and longitudinally thereof.

18. The fastener as defined in claim 17 wherein said gripping and clamping member includes first and second spaced apart teeth extending outwardly thereon, the position of said teeth from said crown being determined by the thickness of said work piece and said substrate, said first tooth having a width equal to the width of said griping and clamping member and being formed by reducing the width of the gripping and clamping member, said second void commencing adjacent said attachment to said body at said piercing point and extends toward said crown and terminates at said first tooth.

19. The fastener as defined in claim 18 wherein said first and second halves of said crown form a radially outwardly extending substantially circular shaped crown having a smooth arcuate periphery and first and second straps formed on said first and second side edges of said body respectively, said straps bordering an opening formed in said body and said straps defining a 180° bend at their mid section.
